(19) United States
(12) Patent Application Publication
(10) Pub. No.: US 2024/0178394 A1
(43) Pub. Date: May 30, 2024

(54) ALL-SOLID-STATE BATTERY

(71) Applicant: TOYOTA JIDOSHA KABUSHIKI KAISHA, Toyota-shi (JP)

(72) Inventor: Toru KIDOSAKI, Miyoshi-shi (JP)

(73) Assignee: TOYOTA JIDOSHA KABUSHIKI KAISHA, Toyota-shi (JP)

(21) Appl. No.: 18/455,874

(22) Filed: Aug. 25, 2023

(30) Foreign Application Priority Data
Nov. 11, 2022 (JP) 2022-180980

(51) Int. Cl. H01M 4/62; H01M 10/052; H01M 10/0562

(52) U.S. Cl. CPC H01M 4/62; H01M 10/052; H01M 10/0562; H01M 2004/028

(57) ABSTRACT

An all-solid-state battery comprising an electrode layer, wherein the electrode layer includes an active material and composite particles, the composite particles include a first solid electrolyte and a coating layer, the coating layer includes a polysiloxane compound, the coating layer covers at least a portion of the first solid electrolyte, and the coating layer covers less than 100% of the first solid electrolyte.

### CROSS-REFERENCE TO RELATED APPLICATION

This application claims priority to Japanese Patent Application No. 2022-180980 filed on Nov. 11, 2022, incorporated herein by reference in its entirety.

### BACKGROUND

### 1. Technical Field

The present disclosure relates to an all-solid-state battery.

### 2. Description of Related Art

Japanese Unexamined Patent Application Publication No. 2020-181640 (JP 2020-181640 A) discloses a coated positive electrode active material for an all-solid-state battery.

### SUMMARY

Lower resistance of an all-solid-state battery (hereinafter, may be abbreviated as a “battery”) is required. One of the resistance components in the battery is a low ion conductive layer formed on the surface of the active material. It is considerable that the low ion conductive layer is formed by oxidation of the surface of the active material. It has been proposed to coat the surface of the active material with a polysiloxane compound so as to inhibit the formation of the low ion conductive layer. This technique is expected to reduce the initial resistance. However, there is room for improvement in a resistance increase rate after durability.

An object of the present disclosure is to reduce a resistance increase rate after durability.

1

An all-solid-state battery includes an electrode layer including an active material and a composite particle.

The composite particle includes a first solid electrolyte and a coating layer.
The coating layer includes a polysiloxane compound.
The coating layer covers at least a part of the first solid electrolyte.
A coverage of the first solid electrolyte by the coating layer is less than 100%.

Hereinafter, the “solid electrolyte” may be abbreviated as “SE”. The SE may be oxidized by repeating the charge and discharge cycle. Oxidation of the SE may promote performance degradation.

In the electrode layer, the coating layer including the polysiloxane compound covers at least a part of the surface of the first SE. The polysiloxane compound may improve the oxidation resistance of the SE. It is expected to improve the cycling properties by improving the oxidation resistance of the SE. However, the coverage of the first SE by the coating layer is less than 100%. When the coverage of the first SE by the coating layer is 100%, an ion-conducting pass is not formed in the electrode layer.

2

In the all-solid-state battery according to 1 above, the polysiloxane compound may include a configuration represented by a formula (1).

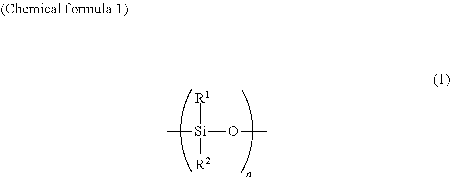

In the above formula (1), R¹ and R² are each independently a hydrogen atom, a hydroxy group, an alkyl group, a carbonyl group, an alkoxy group, a carboxylate group, or an acryloxy group, and n is a real number of 2 or more.

3

In the all-solid-state battery according to 1 or 2 above, the electrode layer further includes a second solid electrolyte.

4
An all-solid-state battery includes a positive electrode layer including a positive electrode active material and a composite particle. The composite particle includes a first solid electrolyte and a coating layer. The coating layer includes a polysiloxane compound. The coating layer covers at least a part of the first solid electrolyte. A coverage of the first solid electrolyte by the coating layer is less than 100%. The polysiloxane compound includes a configuration represented by a formula (1).

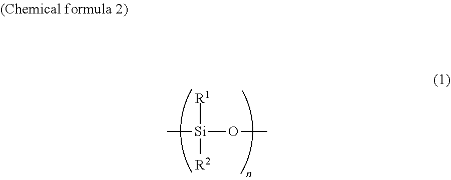

In the formula (1), R¹ and R² are each independently a hydrogen atom, a hydroxy group, an alkyl group, a carbonyl group, an alkoxy group, a carboxylate group, or an acryloxy group, and n is a real number of 2 or more.

5

In the all-solid-state battery according to 4 above, the positive electrode layer further includes a second solid electrolyte.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram of an all-solid-state battery according to the present embodiment;

FIG. 2 is a conceptual diagram of a composite particle according to the present embodiment; and

FIG. 3 is a schematic flowchart of the manufacturing method of the all-solid-state battery according to the present embodiment.

### DETAILED DESCRIPTION OF EMBODIMENTS

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure.

### All-Solid-State Battery

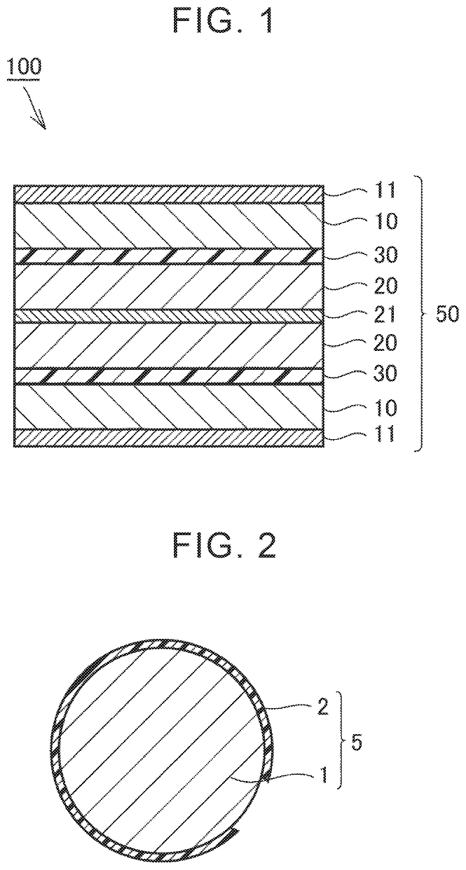

FIG. 1 is a conceptual diagram of an all-solid-state battery according to the present embodiment. In FIG. 1, a cross section parallel to the thickness direction of the battery 100 is conceptually shown. The battery 100 includes a power generation element 50. The battery 100 may include, for example, an exterior body (not shown). The exterior body may store a power generation element 50. The exterior body may be, for example, a pouch made of a metal foil laminate film, a case made of metal, or the like.

The power generation element 50 includes a first electrode layer 10, a separator layer 30, and a second electrode layer 20. The power generation element 50 may include a plurality of the first electrode layer 10, the separator layer 30, and the second electrode layer 20. As an example, the power generation element 50 of FIG. 1 includes two layers each of the first electrode layer 10, the separator layer 30, and the second electrode layer 20. The separator layer 30 is interposed between the first electrode layer 10 and the second electrode layer 20. The separator layer 30 separates the first electrode layer 10 from the second electrode layer 20. The separator-layer 30 may include, for example, a sulfide SE. The separator layer 30 may have a thickness of, for example, 1 to 100 μm.

The second electrode layer 20 has a polarity different from that of the first electrode layer 10. For example, when the first electrode layer 10 is a positive electrode layer, the second electrode layer 20 is a negative electrode layer. The power generation element 50 may further include a first current collector 11 and a second current collector 21. The first current collector 11 contacts the first electrode layer 10. The second current collector 21 is in contact with the second electrode layer 20. For example, when the first electrode layer 10 is a positive electrode layer, the first current collector 11 is a positive electrode current collector. For example, when the second electrode layer 20 is a negative electrode layer, the second current collector 21 is a negative electrode current collector. The first current collector 11 and the second current collector 21 may each independently have a thickness of, for example, 5 to 50 μm. The first current collector 11 and the second current collector 21 are each independently, for example, Al foil, Al alloyed foil, Cu foil, Ni foil, may include a stainless-steel foil or the like.

### Electrode Layer

The first electrode layer 10 and the second electrode layer 20 are collectively referred to as “electrode layers”. The electrode layer may have a thickness of, for example, 10 to 1000 μm. The electrode layer includes an active material and composite particles. The electrode layer may further include, for example, a conductive material, a binder, and the like.

### Active Material

The active material may be in particulate form, for example. The active material may have, for example, a D50 of 1 to 30 micrometers. “D50” indicates a particle size in which the cumulative frequency from the smaller particle size reaches 50% in the volume-based particle size distribution. D50 may be measured by a laser-diffractive particle size analyzer. The amount of the active material may be, for example, 60 to 95 parts by mass with respect to 100 parts by mass of the electrode layer.

The active material may be, for example, a positive electrode active material. The positive electrode active material may include, for example, at least one selected from the group consisting of LiCoO₂, LiNiO₂, LiMnO2, Li(NiCoMn)O₂, and Li(NiCoAl)O₂. For example, “(NiCoMn)” in “Li(NiCoMn)O₂” indicates that the sum of the compositional ratios in parentheses is 1. As long as the sum is 1, the amounts of the individual components are optional.

The active material may be, for example, a negative electrode active material. The negative electrode active material may include, for example, at least one selected from the group consisting of natural graphite, artificial graphite, soft carbon, hard carbon, Si, SiOₓ (0<x<2), Si base alloy, and Li₄Ti₅O₁₂.

The active material may be coated with a coating. The coating may have a thickness of, for example, 5 to 500 nm. The coating may include, for example, an oxide SE, a polysiloxane compound, and the like. The oxide SE may include, for example, a LiNbO₃, Li₃PO₄.

### Composite Particle

FIG. 2 is a conceptual diagram showing composite particles in the present embodiment. The composite particle 5 includes a first solid electrolyte 1 (first SE1) and a coating layer 2. The composite particle 5 may form, for example, aggregates. That is, one composite particle 5 may contain two or more first SE1. The composite particle 5 may have, for example, a D50 of 1 to 50 micrometers.

### First Solid Electrolyte

The first SE1 may form an ion-conducting path in the electrode layer. The first SE1 may be particulate. The first SE1 may have a D50 of, for example, 0.01 to 1 micron. The content of the first SE1 may be, for example, 1 to 30 parts by mass with respect to 100 parts by mass of the electrode layers.

First SE1 may be, for example, at least one selected from the group consisting of sulfide SE, oxide SE, and fluoride SE. Sulfide SE can exhibit enhanced ionic conductivity. The sulfide SE may include, for example, Li, P, and S. The sulfide SE may further include, for example, O, Ge, Si, and the like. The sulfide SE may further contain, for example, a halogen. The sulfide SE may be, for example, a glass-ceramic type or an argyrodite type. Sulfide SE may contain, for example, at least one type selected from a group consisting of LiI—LiBr—Li₃PS₄, Li₂S—SiS₂, LiI—Li₂S—SiS₂, LiI—Li₂S—P₂S₅, Li₂S—P₂S₅ and Li₃PS₄.

For example, “LiI—LiBr—Li₃PS₄” indicates a sulfide SE produced by mixing LiI, a LiBr, and a Li₃PS₄ in any molar ratio (material ratio). The sulfide SE may be synthesized by any methods. The sulfide SE may be synthesized by, for example, a gas phase method, a solid phase method, or a liquid phase method. Li₂S—P₂S₅ contains Li₃PS₄. Li₃PS₄ may be generated, for example, by mixing Li₂S and P₂S₅ with “Li₂S/P₂S₅=75/25 (molar).

### Coating Layer

The coating layer 2 covers at least a part of the first SE1. In the composite particle 5, the coverage of the first SE1 with the coating layer 2 is less than 100%. When the coverage is less than 100%, an ion conduction path is formed in the electrode layer. The coverage is not particularly limited as long as it is more than 0% and less than 100%. The coverage may be, for example, 92% or less, 73% or less, or 52% or less. The coverage may be, for example, 3% or more, 15% or more, or 23% or more.

The coverage can be measured according to Scanning Electron Microscope-Energy Dispersive X-ray Spectrometry (SEM-EDS). That is, SEM images of the composite particle 5 are acquired. The magnification of SEM images is about 30000×. In SEM images of the composite particle 5, elemental mapping of Si derived from the polysiloxane compound is performed and analyzed by image-processing software “ImageJ”. The area of the part where Si is detected is calculated. The ratio (percentage) of the area of the part where Si is detected to the area of the entire composite particle 5 is the coverage. The coverage can be measured in 10 composite particles 5. An arithmetic mean of 10 coverage may be employed as a measurement result.

The coating layer 2 may have a thickness of, for example, 1 to 100 nm. The thickness of the coating layers 2 can be measured in cross-sectional SEM images of the composite particles 5. That is, in the cross-sectional SEM images of the composite particles 5, the thickness of the coating layer 2 is measured at ten locations that are randomly extracted. Ten arithmetic averages may be employed as measurement results.

### Polysiloxane Compound

The coating layer 2 includes a polysiloxane compound. The polysiloxane compound may improve the oxidation resistance of the first SE1. By improving the oxidation resistance of the first SE1, it is expected to improve the cycling properties. The polysiloxane compound can also improve oxidation resistance of an active material, a conductive material, and the like.

The polysiloxane compound includes a structure in which two or more siloxane bonds (—Si—O—) are connected. The polysiloxane compound may be, for example, linear, branched, or cyclic. The polysiloxane compound may include, for example, a structure represented by the following formula (1).

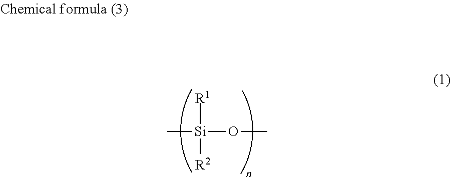

In the above formula (1), R¹ and R² are each independently a hydrogen-atom, a hydroxyl-group, an alkyl-group, a carbonyl-group, an alkoxy-group, a carboxylate-ester group, or an acryloxy-group. These substituents may be further substituted. The polysiloxane compound may, for example, be free of unsaturated bonds, such as “C═C”. A ring may be formed by bonding R¹ and R² to each other. In the above formula (1), n is a real number equal to or greater than 2. n is not particularly limited as long as it is a real number of 2 or more, and may be, for example, 1000 or less, 500 or less, or 100 or less.

The polysiloxane compound may include, for example, 2,4,6,8-tetramethylcyclotetrasiloxane (TMCTS) and the like. TMCTS is a cyclic compound. TMCTS includes, in the above formula (1), a structure in which R¹ is a hydrogen atom, R² is a methyl group, and n is 4.

The polysiloxane compound is added in an amount of less than 50 parts by mass with respect to 100 parts by mass of the first SE1. When the amount of the polysiloxane compound is 50 parts by mass or more, since the coverage is 100%, the ion conduction path is not formed in the electrode layer.

### Second Solid Electrolyte

The electrode layer may include a second solid electrolyte (second SE). The second SE is not coated with a coating layer. The second SE may be the same as or different from the first SE. The detailed description of the second SE is the same as that of the above-described first SE, and therefore will be omitted.

The content ratio (volume %) of the composite particles to the second SE in the electrode layer is, for example, 100:0 to 1:99. By including the composite particle and the second SE in such a region, the reduction of the cell resistivity is expected. In addition, from the viewpoint of cost-saving, it is preferable that the electrode layer include the second SE.

### Other Ingredients

The electrode layers may include, for example, conductive materials such as acetylene black (AB), vapor-grown carbon fibers (VGCF), carbon nanotubes (CNT), and the like. The electrode layers may include, for example, binders such as styrene-butadiene rubber (SBR), acrylate-butadiene rubber (ABR), and polyvinylidene fluoride (PVDF). The blending amount of the conductive material and the binder may be, for example, 0.1 to 10 parts by mass with respect to 100 parts by mass of the electrode layer.

### No. 1

### Synthesis of Sulfide SE

Li₂S, P₂S₅ were weighed to prepare a raw material powder. The mixing ratio of Li₂S, P₂S₅ in the raw material powder was “Li₂S/P₂S₅=75/25 (molar ratio)”. The raw material powder and tetrahydrofuran (THF) were charged into a glass-made container. The mixing ratio of the raw material and THF was “raw material powder/THF=1/20 (mass ratio)”. At 25° C., the raw material powder and THF were stirred for 72 hours. After stirring, the precipitate (powder) was recovered. Precipitates are precursors of sulfide SE. The precursor was dried at 25° C. under an argon atmosphere to form a dried product. The dried product was calcined at 100° C. under atmospheric pressure (open system) for 1 hour to form a first calcined product. The first calcined product was vacuum sealed in a quartz tube. The quartz tube was calcined in a muffle furnace at 140° C. for 12 hours to form a second calcined product. The particle size was adjusted by grinding the second calcined product. After the pulverization, the second calcined product was calcined at 200° C. for 1 hour or more to obtain a sulfide SE.

### Preparation of Composite Particles

100 parts by weight of sulfide SE and 100 parts by weight of a mixed solvent of heptane and dibutyl ether (heptane/dibutyl ether=8/2 (by volume)) were mixed and stirred at a dew point of −70° C. under a nitrogen atmosphere. Then, a slurry was obtained. Composite particles were obtained by adding 0.1 parts by weight of a polysiloxane compound to the slurry, stirring for 1 hour, and vacuum-drying at 120° C. for 12 hours.

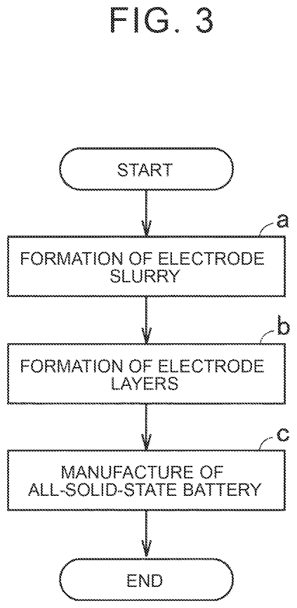

FIG. 3 is a schematic flowchart of the manufacturing method of the all-solid-state battery according to the present embodiment. A test battery was manufactured according to the flowchart of FIG. 3.

### (a) Formation of Electrode Slurry

A “fill mix (registered trademark)” made by Plamix Co. was prepared as a kneading device. In the mixing vessel of the fill mix, 80 parts by weight of a positive electrode active material (LiN_{1/3}Co_{1/3}Mn_{1/3}O₂), 9.51 parts by weight of composite particles, and 2.5 parts by weight of a conductive material (VGCF) were charged. Thereafter, a binder dispersion liquid (SBR dispersion liquid, 5% concentrated) and 32.21 parts by weight of a dispersion medium (tetralin) were charged into a mixing vessel. The solids content was 69% (mass fraction). Further, the mixture was kneaded to form a positive electrode slurry. During kneading, the peripheral speed of the fill mix was adjusted within 5 to 30 m/s.

### (b) Formation of Electrode Layers

A coating film was formed by coating the positive electrode slurry on the positive electrode current collector (Al foil) with a blade-type applicator. The coating film was dried at 100° C. for 30 minutes to form a positive electrode layer.

(c) Manufacture of all-Solid-State Battery

### (Formation of Negative Electrode Layer)

In the fill mix, 18.6 parts by mass of a negative electrode active material (Si), 8.69 parts by mass of a sulfide SE, a binder dispersion liquid (SBR dispersion liquid, concentration: 5%) and a dispersion medium (diisobutyl ketone) were mixed to form a negative electrode slurry. The solid content of the negative electrode slurry was 43% (mass fraction). During kneading, the peripheral speed of the fill mix was adjusted within 5 to 30 m/s. A coating film was formed by applying a negative electrode slurry to the surface of a negative electrode current collector (Ni foil) by a blade-type applicator. The coating film was dried at 100° C. for 30 minutes to form a negative electrode layer.

### Formation of the Separator Layer

A separator slurry was formed by kneading 40 parts by mass of a sulfide SE, a binder dispersion liquid (ABR dispersion liquid, concentration: 5%), and a mixed dispersion medium (heptane: 25.62 parts by mass, diisobutyl ketone: 8 parts by mass) with an ultrasonic homogenizer. The solids content of the separator slurry was 50% (mass fraction). The separator slurry was coated on the substrate (Al foil) to form a coating film. The coating was dried at 100° C. for 30 minutes to form a separator layer.

### Assembly

By pressing 20 kN, the separator layer and the positive electrode layer were sequentially crimped on the surface of the negative electrode layer, thereby forming a power generation element. The power generation element was densified by performing roll pressing on the power generation element. The roll linear pressure was 4 ton/cm and the roll gap was 200 micrometers. A positive electrode current collector (Al foil) was adhered to the positive electrode layers. A pouch made of Al laminated film was prepared as an exterior body. The power generation element was enclosed in an outer casing. A restraining member was attached to the exterior of the outer casing to apply 5 MPa force to the power generating element. As described above, a test battery (an all-solid-state battery including a positive electrode layer) was manufactured.

### Initial Charge and Discharge

CCCV charge/discharge (charge upper limit voltage 4.55 V, discharge lower limit voltage 2.5 V) was performed. The designed capacitance of the cell was 0.3 Ah. The rate of CC charge or CC discharge was 0.1 C. At 1 C time rates, the designed capacitance is discharged in one hour.

### No. 2 to 7

Test cells were prepared as in No. 1 except that the amounts of polysiloxane compounds added were varied (see Table 1 below). The amounts added in Tables 1 below are parts by mass of the polysiloxane compound with respect to 100 parts by mass of the sulfide SE.

### No. 8

Test cells were fabricated in the same manner as No. 1 except that the composite particle was changed to a sulfide SE in forming the positive electrode slurry.

### No. 9

In No. 9, the positive electrode active material was coated with a polysiloxane compound to form a coated positive electrode active material. The coating amount (the addition amount of the polysiloxane compound) is 50 parts by mass with respect to 100 parts by mass of the positive electrode layer. Test cells were fabricated in the same manner as No. 1, except that a coated positive electrode active material was used.

### No. 10 to 20

Sulfide SE and the same composite particle as No. 2 were prepared. Test cells were produced in the same manner as No. 1, except that the sulfide SE and the composite particle were added in the proportions listed in Table 1.

### Evaluation

### Coverage Rate

By the methods described above, the coverage of the composite particles of the respective No. was calculated. The results are shown in Table 1.

### Resistance Increase

In the test battery, a charge/discharge cycle was performed for 1000 cycles, and the resistivity increase rate was determined. The resistivity increase rate was calculated by the following Expression (2). The results are shown in Table 1. Note that the resistance after three cycles was set as the initial resistance.

Resistance increase rate (%)=100×(resistance after 1000 cycles-initial resistance)/initial resistance (2).

TABLE 1

| | Amount of | | | | | |
|---|---|---|---|---|---|---|
| | polysiloxane | | | | Resistance | |
| | compound | Coverage | Composite | Initial | after 1000 | Resistance |
| | added (parts | rate | Particles:Sulfide | resistance | cycles | increase |
| No. | by mass) | (%) | SE (Volume %) | (Ω · cm²) | (Ω · cm²) | (%) |
| 1 | 0.1 | 3 | — | 103 | 251 | 144 |
| 2 | 0.5 | 15 | — | 104 | 252 | 142 |
| 3 | 1 | 23 | — | 102 | 254 | 149 |
| 4 | 5 | 52 | — | 99 | 243 | 145 |
| 5 | 15 | 73 | — | 102 | 254 | 149 |
| 6 | 30 | 92 | — | 109 | 263 | 141 |
| 7 | 50 | 100 | — | 184 | 645 | 251 |
| 8 | — | — | — | 148 | 523 | 253 |
| 9 | 50*1 | 50*2 | — | 125 | 402 | 222 |
| 10 | 5 | 52 | 1:99 | 103 | 245 | 138 |
| 11 | 5 | 52 | 5:95 | 105 | 242 | 130 |
| 12 | 5 | 52 | 10:90 | 102 | 239 | 134 |
| 13 | 5 | 52 | 20:80 | 102 | 235 | 130 |
| 14 | 5 | 52 | 30:70 | 108 | 240 | 122 |
| 15 | 5 | 52 | 40:60 | 101 | 235 | 133 |
| 16 | 5 | 52 | 50:50 | 99 | 238 | 140 |
| 17 | 5 | 52 | 60:40 | 104 | 241 | 132 |
| 18 | 5 | 52 | 70:30 | 106 | 246 | 132 |
| 19 | 5 | 52 | 80:20 | 101 | 245 | 143 |
| 20 | 5 | 52 | 90:10 | 103 | 239 | 132 |

*1The amount of the positive electrode active material added is 100 parts by mass
*2The coating ratio of the positive electrode active material is defined

### Results

When a composite particle having a coverage of less than 100% is used, the resistivity-increasing rate tends to decrease (see No. 1 to 6).

Even when the content (volume %) of the composite particles and the sulfide SE in the positive electrode layer is 100:0 to 1:99, the resistivity increasing rate tends to decrease (see No. 4, 10 to 20).

What is claimed is:

1. An all-solid-state battery comprising an electrode layer including an active material and a composite particle, wherein:
the composite particle includes a first solid electrolyte and a coating layer;
the coating layer includes a polysiloxane compound;
the coating layer covers at least a part of the first solid electrolyte; and
a coverage of the first solid electrolyte by the coating layer is less than 100%.

2. The all-solid-state battery according to claim 1, wherein:
the polysiloxane compound includes a configuration represented by a formula (1): 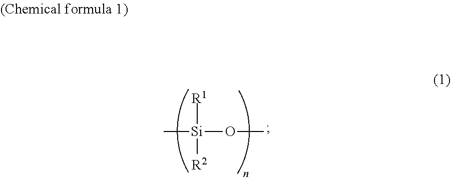
and
in the formula (1), R¹ and R² are each independently a hydrogen atom, a hydroxy group, an alkyl group, a carbonyl group, an alkoxy group, a carboxylate group, or an acryloxy group, and n is a real number of 2 or more.

3. The all-solid-state battery according to claim 1, wherein the electrode layer further includes a second solid electrolyte.

4. An all-solid-state battery comprising a positive electrode layer including a positive electrode active material and a composite particle, wherein:
the composite particle includes a first solid electrolyte and a coating layer;
the coating layer includes a polysiloxane compound;
the coating layer covers at least a part of the first solid electrolyte;
a coverage of the first solid electrolyte by the coating layer is less than 100%;
the polysiloxane compound includes a configuration represented by a formula (1):
(Chemical formula 2) 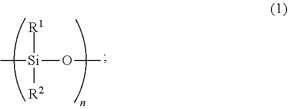
and
in the formula (1), R¹ and R² are each independently a hydrogen atom, a hydroxy group, an alkyl group, a carbonyl group, an alkoxy group, a carboxylate group, or an acryloxy group, and n is an actual number of 2 or more.

5. The all-solid-state battery according to claim 4, wherein the positive electrode layer further includes a second solid electrolyte.
